(19) United States
(12) Patent Application Publication
(10) Pub. No.: US 2009/0147062 A1
(43) Pub. Date: Jun. 11, 2009

(54) INK CARTRIDGE

(75) Inventor: Daniel Sulser, Wald (CH)

Correspondence Address: MICHAEL BEST & FRIEDRICH LLP, 100 E WISCONSIN AVENUE, Suite 3300, MILWAUKEE, WI, 53202, US

(73) Assignee: PELIKAN HARDCOPY PRODUCTION AG, Egg (CH)

(21) Appl. No.: 11/917,404

(22) PCT Filed: Jul. 4, 2006
(86) PCT No.: PCT/EP2006/006505

§ 371 Date: Dec. 13, 2007

(30) Foreign Application Priority Data
Jul. 4, 2005 (DE) 10 2005 031 143.1
Dec. 22, 2005 (DE) 20 2005 020 053.0

(51) Int. Cl. B41J 2/175

(52) U.S. Cl. 347/86

(57) ABSTRACT

Ink cartridge (10) for insertion into a cartridge receptacle (12) of an inkjet printer, having a housing (14), in which at least one ink storage chamber (20) is located, having at least one connection piece (24), which is provided especially on the underside (22) of the housing (14), for connecting the ink storage chamber (20) to a supply connection (26) provided at the inkjet printer when the ink cartridge (10) is inserted into the cartridge receptacle (12), and having a locking catch (32) resiliently pre-biased into a locking position, which locking catch projects from the outside of a side wall (28) of the housing (14) adjacent to the underside (22), and at which locking catch a locking edge (40) is formed by means of which the locking catch (32), in its locking position for locking the ink cartridge (10) in the cartridge receptacle (12), is lockable with a matching locking edge (for example locking aperture 59) provided on the cartridge receptacle (12), wherein the ink cartridge (10) is supported in such a manner underneath the locking catch (32) that a torque (M) holding the connection piece (24) against the supply connection (26) is exerted about that support.

The invention relates to an ink cartridge according to the preamble of claim 1 for insertion into a cartridge receptacle of an inkjet printer.

Changeable ink cartridges of the kind mentioned at the outset are generally known and are used to supply inkjet printers with ink. The ink cartridges usually comprise at least one ink chamber in which liquid ink is stored. The chambers of an ink cartridge may be separated from one another fluid-mechanically, each with its own ink-inlet and ink-outlet apertures, or may be arranged in flow connection one below another, with common ink-inlet and ink-outlet apertures. Fluid-mechanically separated ink chambers are used especially in ink cartridges for colour inkjet printers to accommodate different coloured inks. Ink cartridges having a single ink chamber or having ink chambers connected fluid-mechanically one below another are used both in mono inkjet printers and colour inkjet printers. In colour inkjet printers especially, however, both kinds of cartridge can be used jointly, for example a separate cartridge for black ink and a separate cartridge having, for example, three chambers for a coloured ink each, is provided, or both the black ink and, for example, three different coloured inks are provided each in its own cartridge having one or more ink chambers connected fluid-mechanically. To operate the inkjet printer, one or more ink cartridges are inserted into the cartridge receptacle in the printer, which receptacle is arranged so as either to move simultaneously at the print head or be stationary in the housing of the inkjet printer. When the inkjet cartridge is inserted, the or each ink-outlet aperture, or the or each connection piece, of the or each ink chamber is connected fluid-mechanically with the corresponding supply connection in the cartridge receptacle.

For an operationally reliable supply of ink it is necessary for the or each connection piece of the ink cartridge to be coupled in air-tight manner to the or each supply connection of the printer. This is achieved by the ink cartridge's being held in a predetermined defined installation position in the cartridge receptacle and locked therein.

An ink cartridge lockable in a cartridge receptacle is known, for example, from EP 1 481 809 A2, which is attributable to the Applicant. That ink cartridge is distinguished by the fact that the locking catch has a hinged part which has a pivot axis that extends approximately parallel to the plane of insertion in which plane the ink cartridge is to be inserted into the cartridge receptacle, and that the hinged part is followed by a locking part on which the locking edge has been formed so as to run transversely to the plane of insertion.

By that means, correct insertion of the ink cartridge into the cartridge receptacle of the printer is achieved with a defined reliable retention of the ink cartridge in the cartridge receptacle, thus ensuring that the admission of air into the ink supply between the or each connection piece of the ink cartridge and the or each supply connection of the printer is avoided.

In the ink cartridge according to EP 1 481 809 A2, in the vicinity of the underside of the housing a positioning aid, in the form of a positioning edge, is furthermore formed at the side wall that is remote from and opposite to the side wall of the housing from which the locking catch projects. With the aid of that positioning edge, insertion of the ink cartridge into the cartridge receptacle can be facilitated. In addition, there is provided in the cartridge receptacle a corresponding receiving aperture into which the positioning edge can be inserted when the ink cartridge is being introduced. That positioning edge forms a pivot for the insertion movement of the ink cartridge into the cartridge receptacle.

Starting from that prior art, the problem underlying the present invention is further to develop an ink cartridge of the kind mentioned at the outset in such a manner that, while the advantages of the same are retained, a fluid-tight connection is assured between the connection piece of the ink cartridge and the supply connection of the cartridge receptacle.

That problem is solved in accordance with the invention by an ink cartridge having the features in claim 1.

Accordingly, a central point of the present invention is that the ink cartridge is supported in such a manner underneath the locking catch that a torque holding the connection piece against the supply connection is exerted about that support. The torque ensures that an especially fluid-tight connection is achieved between the connection piece and the supply connection, which renders possible correct operation of the printer in terms of ink supply even in the event of mechanical actions on the printer or the cartridge.

In a preferred embodiment, there is arranged on, especially integrally formed with, the side wall of the housing from which the locking catch projects, a positioning element, especially in the form of a positioning rail, which, when the ink cartridge is in the inserted state, is supported on the boundary wall of the cartridge receptacle facing that housing side wall. In accordance with the invention, therefore, there is no longer the need for a separate receiving aperture in the cartridge receptacle for a positioning aid, especially a positioning edge, formed on the housing of the ink cartridge. The ink cartridge developed in accordance with the invention is thus suitable for a cartridge receptacle that has or does not have a receiving aperture for a positioning aid, and can therefore be used universally.

As a result of the fact that the positioning element exercises a supporting function when the ink cartridge is in the inserted state, the ink cartridge is held, and thus secured, in the inserted state by the positioning element.

Alternatively, the positioning element can also be formed on the boundary wall of the cartridge receptacle that faces the side wall of the housing of the ink cartridge from which the locking catch projects.

When the positioning element is in the form of a positioning rail, it extends preferably approximately parallel to the plane of insertion of the ink cartridge in which the cartridge is to be pivoted and inserted into the cartridge receptacle.

At this point attention should, however, be drawn to the fact that the positioning element can also be formed as a peg or the like, the free end of which is preferably rounded, especially formed in the shape of a hemisphere.

When the positioning element is in form of a positioning rail, at least that region of the outer boundary thereof which faces the underside of the housing includes an arcuate portion. This ensures that the pivoting of the ink cartridge into and out of the cartridge receptacle is not hindered by the positioning rail.

Also of special advantage in connection with the afore-described further development are the features according to claims 5 to 8. The arrangement of the pivot axis parallel to the plane of insertion ensures that, when the ink cartridge is inserted, the locking part comes with its outer edge only into roughly point contact with the upper edge of the cartridge receptacle, whereas that contact region in locking means according to the prior art, for example according to EP 0 879 703 A2, is either area-based or is at least a line contact. When the ink cartridge is being inserted, the locking catch is moved out of its rest position. Unlike the mentioned prior art, the locking means according to the invention facilitates the insertion of the ink cartridge into the cartridge receptacle because of the lower frictional forces. In the final phase of the insertion movement of the ink cartridge, the locking edge then locks into the locking aperture, as a result of which the ink cartridge is secured in the cartridge receptacle, that security being additionally safeguarded by the positioning element according to the invention.

In addition, attention should also be drawn to the fact that, as a result of the pivot axis which extends parallel to the plane of insertion of the ink cartridge, about which axis the locking catch is moved out, the ink cartridge is biased, by the pre-biasing force by which the locking catch abuts the inside of the cartridge receptacle, into the longitudinal direction of the ink cartridge, that is, into a direction perpendicular to the side wall. Simultaneously, the locking catch generates a torque, which acts about the base-side connection piece, by means of which torque the ink cartridge in the cartridge receptacle is in addition biased in a direction different from the direction of action of the pre-biasing force, whereby an improved and more secure retention of the ink cartridge in the cartridge receptacle is achieved and whereby, especially, the risk of air entering into the ink supply is also reduced. For the rest, reference is made in respect of the advantages of the features according to claims 4 to 7 to EP 1 481 809 A2, which is attributable to the applicant. The subject matter of EP 1 481 809 A2 is in respect of the features of claims 5 to 8 included in the subject matter of the present application.

Preferably, the support comprises at least one positioning element, which is provided on the underside of the ink cartridge and, in the inserted state, is supported on the base of the cartridge receptacle. As a result of the co-operation of the positioning element with the base of the cartridge receptacle, a fixing of the positioning element which is effective in at least one direction is achieved, so that a torque can be applied about that positioning element.

The support may comprise a positioning peg, which is arranged on the underside of the housing and, in the inserted state, co-operates with a positioning aperture of matching shape arranged in or at the base of the cartridge receptacle or with a positioning step protruding from the base. In a simple and simultaneously effective way, that arrangement realises the principle underlying the present invention, according to which a reliable connection is ensured between the connection piece and the supply connection by application of a torque about a support underneath the locking catch.

An improved introduction of force into the cartridge receptacle is achieved as a result of the fact that a face of the positioning peg, which face is provided for resting on the positioning aperture, is of planar form.

Insertion of the ink cartridge into the cartridge receptacle is facilitated as a result of the fact that the free end of the positioning peg has a bevel.

In an alternative arrangement of the invention, the support comprises at least one positioning aperture, which is provided at the underside of the ink cartridge and, in the inserted state, is supported on the base of the cartridge receptacle. Thus, the principle explained in the preceding exemplary embodiment, according to which principle an element protruding from the underside of the ink cartridge co-operates with a matching aperture in the base of the cartridge receptacle, is reversed. The co-operation of a positioning aperture provided in or at the underside of the ink cartridge with the base of the cartridge receptacle, especially with a corresponding profiled location on the base, likewise results in its being possible for a torque acting about the positioning aperture to be exerted on the ink cartridge.

In a preferred arrangement, the support comprises at least one, especially two, notches, which are formed in the side edges of the underside of the ink cartridge and co-operate with at least one, especially two, matching areas of ribbing on the base of the cartridge receptacle.

In the following, the invention is explained in detail with reference to exemplary embodiments illustrated in the accompanying drawings in which:

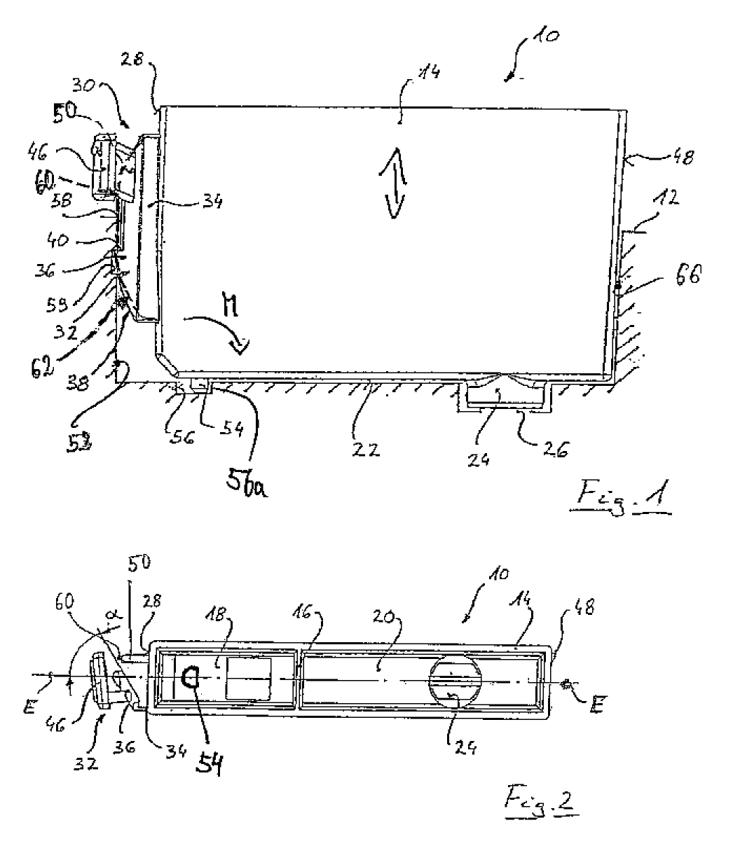

FIG. 1 is a side view of an exemplary embodiment of an ink cartridge according to the invention having a locking catch for locking the ink cartridge in a cartridge receptacle of an inkjet printer, in which view the top of the ink cartridge is not shown;

FIG. 2 is a plan view of the ink cartridge according to FIG. 1;

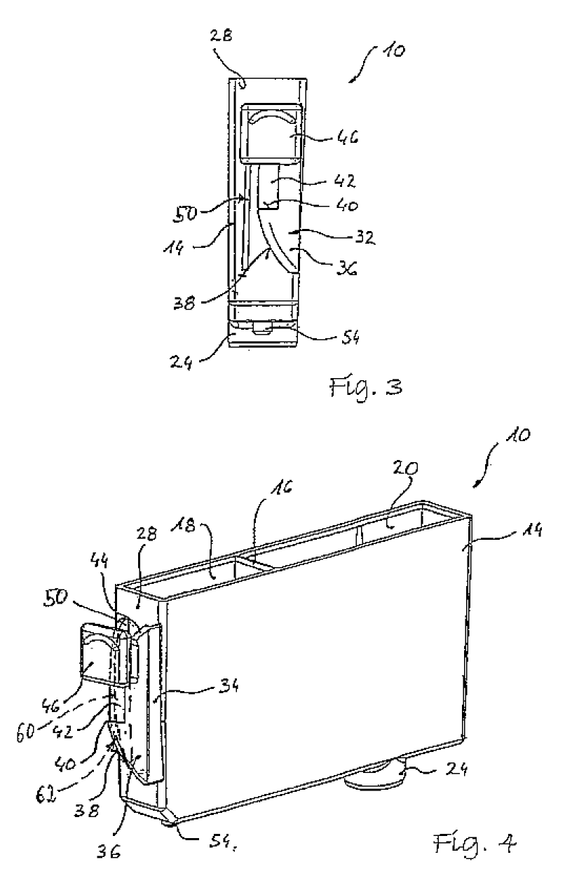

FIG. 3 is a front view of the ink cartridge according to FIG. 1;

FIG. 4 is a perspective view of the ink cartridge according to FIG. 1;

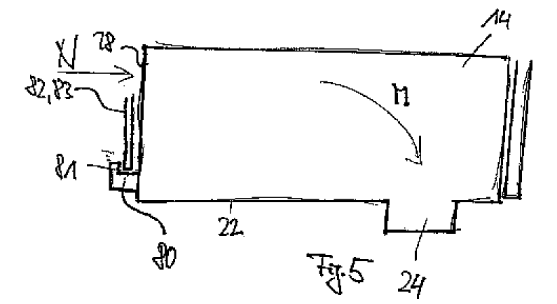

FIG. 5 is a diagrammatic side view of an ink cartridge according to a further exemplary embodiment.

FIGS. 1 to 4 show a first exemplary embodiment of an ink cartridge 10 according to the invention which is insertable into a cartridge receptacle 12 of an inkjet printer, wherein the cartridge receptacle 12 is provided in known manner either directly at the print head or alternatively remote therefrom in the printer housing. For the sake of clarity, the top of the ink cartridge 10 is not shown.

The ink cartridge 10 has a housing 14 made of plastics material which, as shown especially in FIG. 2 and FIG. 4, is subdivided by a separating wall 16 into an ink chamber 18 (on the left in FIG. 2) and a storage chamber 20 which is in flow connection with the ink chamber 18. There is usually accommodated in the storage chamber 20 a capillary ink store, not shown here, for example a porous sponge or a fleece material, in which the liquid ink is stored.

The storage chamber 20 is in flow connection with a connection piece 24 which is formed on the underside 22 of the housing and which, when the ink cartridge 10 is inserted correctly into the cartridge receptacle 12 of the inkjet printer, is coupled to a supply connection 26 of the inkjet printer, with the result that ink is supplied from the ink cartridge 10 by the ink head as required.

To ensure that ink is supplied correctly from the ink cartridge 10 into the inkjet printer, the ink cartridge 10 needs to be arranged in a defined position in the cartridge receptacle 12 and secured therein. To ensure a correct and defined retention of the ink cartridge 10 in the cartridge receptacle 12, the ink cartridge 10 for that purpose comprises at its front wall 28, shown on the left in FIGS. 1 and 2, a locking means 30, the structure of which is explained in detail below.

There serves as a locking means 30, a locking catch 32, which has a hinged part 34 formed in one piece with the side wall 28 and projecting approximately at right angles from the side wall 28 of the housing 14. The hinged part 34 extends at least approximately perpendicularly to the underside 22 of the housing 14 and thus at least approximately parallel to a plane of insertion E (see FIG. 2) in which the ink cartridge 10, in its installation position, is pivoted and pressed into the cartridge receptacle 12 (see double arrow in FIG. 1).

The hinged part 34 is followed by a locking part 36, the material strength of which is about two to five times greater, especially three to four and a half times greater, than that of the hinged part 34. The locking part 36 likewise extends approximately perpendicularly relative to the underside 22 of the housing 14, but is angled away by a predetermined angle of approximately from 25° to 35° relative to the side wall 28, resulting in an angle α of approximately from 65° to 55° relative to the plane of insertion E.

The side edge 38 of the locking part 36 pointing in the direction of the underside 22 of the housing 14 has an arcuate shape and terminates in a locking edge 40 extending transversely to the plane of insertion E, which locking edge 40 is formed on the locking part 36, a recess having been made in a portion of the locking part during shaping and a face 42 extending approximately parallel to the side wall 28 having been formed.

In the vicinity of the upper side edge 44 of the locking part 36 there is formed, spaced apart from the face 42, an approximately rectangular operating element 46 by means of which the locking part 36 can be moved out manually against a pre-biasing force generated by the material resiliency of the hinged part 34.

All of the remaining side walls, especially also the side wall arranged opposite to the side wall 28, are flat.

As can also be seen in FIGS. 1 to 4, there is integrally formed, with the side wall 28 from which the locking catch 32 projects, a positioning element in the form of a positioning rail extending parallel to the hinged part 34, the positioning rail being supported on the boundary wall 52 of the cartridge receptacle 12 facing that side wall 28 when the ink cartridge 10 is in the inserted state. The said positioning rail is indicated by the reference numeral 50. As can be seen especially in FIG. 1, but also in FIGS. 5 and 6, in which the locking means 30 has been omitted for clearer illustration of the positioning rail 50, the region of the outer boundary 60 of the positioning rail 50 that faces the underside 22 of the housing 14 has an arcuate portion 62. In the embodiment shown, the upper portion of the outer boundary 60 of the positioning rail 50 is also arcuate. For handling, that is for pivoting into and out of the cartridge receptacle 12, the lower arcuate portion 62 is of decisive importance. In side view, that arcuate portion is set back somewhat relative to the likewise arcuate side edge 38 of the locking part 36, so that the function of the locking part 36 is not impaired by the positioning rail 50.

The middle portion of the outer boundary or boundary edge 60 of the positioning rail is preferably of rectilinear form and extends parallel to the side wall 28.

The maximum height of the positioning rail 50 is such that the sum of that and of the length of the housing 14 is slightly greater than the inside length of the cartridge receptacle 12, with the result that the ink cartridge 10 is held inside the cartridge receptacle 12 with axial pre-bias. The magnitude of that pre-bias is determined by the height of the positioning rail 50. Of course, the positioning rail must not be of such a dimension that the function of the locking means 30 is lost as a result. The afore-mentioned length excess is in the p range.

In the embodiment according to FIGS. 1 to 4, there is formed on the underside 22 of the ink cartridge 10 a positioning peg 54 which, when the ink cartridge 10 is in the inserted state, holds the ink cartridge 10 in a defined position in the cartridge receptacle 12 by engaging with a positioning aperture 56 provided in the cartridge receptacle 12.

For the purpose of clarity, a small gap has been drawn between the positioning peg 54 and the wall 56a of the positioning aperture 56, which is arranged on the side of the connection piece 24. In practice, however, the positioning peg 54 abuts that wall 56a.

In the inserted state, the positioning rail 50 and the positioning peg 54 are biased, so that a torque M acts about the positioning peg 54. As shown in FIG. 1, the torque M acts in the clockwise direction, so that there is a force acting on the connection piece 24 that holds and presses the connection piece 24 against the supply connection 26.

In detail, the torque M is generated as follows: in the inserted state, the positioning rail 50 presses against the wall or side 52 of the cartridge receptacle 12 that lies opposite to the side wall 28 containing the locking catch 32. The reaction force produced as a result acts perpendicularly on the side wall 28, the introduction of force taking place at a distance from the positioning peg 54. In addition, the support is in principle arranged underneath the locking catch 32, especially in the vicinity of the bottom corner between the underside 22 and the side wall 28. Specifically, the positioning peg 54 is integrally formed with the underside 22 of the ink cartridge 10, thereby achieving the introduction of force in the region of the positioning rail 50 at a distance from the positioning peg 54, which, together with the support of the positioning peg 54 on the wall 56a of the positioning aperture 56, leads to a lever arrangement and thus to the desired torque M.

In principle it is also possible for the spring force of the locking catch 32 to be made so great that an adequate normal force relative to the side wall 28 can be generated by the locking catch 32 alone. Locking of the ink cartridge 10 would, of course, be made difficult as a result. For that reason it is more advantageous for the torque M to be applied by the positioning rail 50, so that the function of the locking catch 32 is exclusively that of locking and hence, in terms of the spring force to be applied, the locking catch 32 can be arranged to be relatively resilient.

To ensure as good as possible an introduction of force from the positioning peg 54 into the positioning aperture 56 and the cartridge receptacle 12, that is to say, to avoid stress peaks in the positioning peg 54, the face of the positioning peg 54 that is destined to rest on the wall 56a is flattened off or of planar form. As a result, the transfer of force from the positioning peg onto the positioning receptacle 12 is area-based. In addition, the positioning peg 54 is bevelled to facilitate pushing the positioning peg 54 into the positioning aperture.

A further possible way of generating the torque M in the desired direction is illustrated by way of the further exemplary embodiment according to FIG. 5. In that embodiment, the locking catch 32 and the positioning rail 50 have been omitted for the purpose of simplicity. As FIG. 5 shows, a hook-shaped positioning element is provided underneath the locking catch 32, that is, in the region of the bottom corner between the underside 22 and the side wall 28. The hook-shaped positioning element comprises a hook part 81 at least a portion of which extends parallel to the side wall 28, which hook part 81 is spaced apart from the side wall 28 and forms a receiving aperture therewith. The hook part 81 co-operates, in the inserted state, with a further positioning element 82 in the form of a rod-shaped member 83, which is likewise arranged parallel to the side wall 28. Relative to the hook part 81, the rod-shaped member 83 is arranged displaced inwards towards the side wall 28, so that the rod-shaped member 83, in the inserted state, engages into the recess formed between the hook part 81 and the side wall 28.

For the sake of simplicity, a gap is shown between the hook part 81 and the lower free end of the rod-shaped member 83. In practice, of course, the rod-shaped member 83 abuts the inside of the hook part 81, that is, the side of the hook part 81 that faces the side wall 28. As a result of the normal force acting on the side wall 28 in the arrow direction N, which force is generated by the co-operation of the positioning rail 50 (not shown) with the inside 52 (also not shown) of the cartridge receptacle 12, a torque M about the hook-shaped positioning element 80 is generated.

A further exemplary embodiment of the invention, which is not shown, is based on the fact that, instead of a protruding profile provided on the ink cartridge 10, for example in the form of a positioning peg 54, it is possible, in principle, to provide a positioning aperture, which is formed in the wall, especially of the underside 22 of the ink cartridge. That positioning aperture co-operates with a matching profile formed in the base of the cartridge receptacle 12, so that a torque M can be applied about that support in the form of the positioning aperture. In that arrangement, the positioning aperture (not shown) co-operates with the positioning rail 50 in the same way as does the positioning peg 54. The positioning aperture can, for example, take the form of a notch or two notches which are formed in the side edges of the underside 22 of the ink cartridge 10. The side edges (not shown) in that arrangement are formed as rails which project beyond the underside 22 or base of the ink cartridge and which run parallel to the underside 22 and parallel to one another. There is formed as a counterpiece on the base of the cartridge receptacle an area of ribbing which, in the inserted state of the ink cartridge 10, engages in the notches.

The use of the positioning peg 54 as a positioning aid has the advantage that the ink cartridge 10 can be inserted with a rectilinear movement into the cartridge receptacle 12, as indicated by the double arrow in FIG. 1, but a rotary insertion movement is not excluded. The rectilinear insertion movement has the advantage that tipping or jamming of the ink cartridge in the cartridge receptacle 12 is almost completely avoided. During insertion of the ink cartridge 10, the positioning peg 54 comes into engagement with the positioning aperture 56, the positioning peg 54 abutting the wall 56a of the position aperture 56 facing the connection piece 24.

In the final phase of the insertion movement of the ink cartridge 10 into the associated cartridge receptacle 12, the locking edge 36 locks into the locking aperture 59, as a result of which the ink cartridge 10 is secured in the cartridge receptacle 12. As a result of the positioning peg 54, which is effective after the locking edge 36 has locked into the locking aperture 59, the ink cartridge 10 is held with resilient pre-bias between the positioning rail 50 and the positioning peg 54, the torque M, already explained, acting about the positioning peg 54. The ink cartridge 10 is simultaneously biased into the longitudinal direction, that is, into a direction perpendicular to the side wall 28. In addition, the locking catch 32 ensures that the ink cartridge 10 can be moved out of the cartridge receptacle 12 again only after the locking has been released.

By appropriate configuration of the arcuate shape of the side edge 38, it is possible for the torque acting during displacement, and thus the force acting against the insertion movement of the ink cartridge 10, to be influenced in a purposive manner. As a result of the slight spacing of the point of contact between the edge of the cartridge receptacle 12 and the arcuate side edge 38 relative to the pivot axis running through the hinged part 34, a further achievement is that, owing to that slight spacing, the inherent resiliency of the material from which the locking catch 32 has been produced plays at most a subordinate role for the forces that act during insertion, so that also by that means a more exact definition of the forces that are actually acting is possible.

When the ink cartridge 10 is to be removed from the cartridge receptacle 12, the locking catch 32 merely needs briefly to be moved against the pre-biasing force with the aid of the operating element 46. As soon as the locking edge 40 is out of engagement with the locking aperture 59, the ink cartridge 10 is pressed out of the cartridge receptacle 12 by the arcuate shape of the side edge 38 and by the pre-biasing force by which the locking catch 30 is pre-biased. The positioning rail 50 offers only slight resistance to that pivot movement, especially in view of the arcuate boundary edge 62 in the lower region of the positioning rail 50, which edge 62 is set back slightly relative to the arcuate side edge 38.

The positioning rail 50 preferably also acts as a stop for the maximum displacement of the locking catch 32 towards the side wall 28. By that means the locking catch 32 is prevented from being broken off as a result of mechanical overloading of the hinged part 34.

With regard to the locking part 36, it should also be mentioned that it extends angled away at a predetermined angle α, which is preferably between 55° and 65°, relative to the plane of insertion E.

It should furthermore also be mentioned that the locking part 36 and/or the positioning rail 50 have been produced from the same material as the hinged part 34 and essentially have a material strength that is from two to five times greater, especially from three to four and a half times greater, than that of the hinged part 34.

All features disclosed in the application documents are claimed as important to the invention insofar as they are novel, individually or in combination, compared with the prior art.

### REFERENCE NUMERALS

10 ink cartridge

12 cartridge receptacle

14 housing

16 separating wall

18 ink chamber

20 storage chamber

22 underside

24 connection piece

26 supply connection

28 side wall

30 locking means

32 locking catch

34 hinged part

36 locking part

38 lower side edge extending in an arcuate shape

40 locking edge

42 face

44 upper side edge

46 operating element

48 side wall

50 positioning rail

52 boundary wall

54 positioning peg

56 positioning aperture

56a wall

58 edge

59 locking aperture

60 outer boundary

62 arcuate portion

64 arrow

66 inside

68 arcuate portion

70 side wall

72 arcuate portion

E plane of insertion

80 hook-shaped positioning element

81 hook part

82 wide positioning element

83 rod-shaped member

1-14. (canceled)

15. An ink cartridge for insertion into a cartridge receptacle of an inkjet printer, said ink cartridge comprising:
a housing;
at least one ink storage chamber located in said housing;
at least one connection piece provided on the underside or elsewhere on the housing and operative to connect said ink storage chamber to a supply connection provided at the inkjet printer when said ink cartridge is inserted into said cartridge receptacle; and
a locking catch resiliently pre-biased into a locking position, said locking catch projecting from the outside of a side wall of said housing adjacent to the underside, and at which locking catch a locking edge is formed by means of which the locking catch, in its locking position for locking the ink cartridge in the cartridge receptacle, is lockable with a locking aperture or other matching locking edge provided on said cartridge receptacle;
wherein the support of said ink cartridge underneath said locking catch is such that that a torque holding said connection piece against said supply connection is exerted about that support.

16. An ink cartridge according to claim 15, wherein there is arranged on, or integrally formed with, the side wall of the housing from which the locking catch projects, a positioning rail or element which is supported on the boundary wall of the cartridge receptacle facing that housing side wall when the ink cartridge is in the inserted state.

17. An ink cartridge according to claim 16, wherein said positioning rail extends approximately parallel to the plane of insertion of said ink cartridge into said cartridge receptacle.

18. An ink cartridge according to claim 16, wherein at least the region of the outer boundary edge of said positioning rail facing the underside of said housing includes an arcuate portion.

19. An ink cartridge according to claim 15, wherein said locking catch has a hinged part which defines a pivot axis that extends approximately parallel to the plane of insertion of said ink cartridge into said cartridge receptacle, and wherein said hinged part is followed by a locking part at which said locking edge runs transversely to the plane of insertion.

20. An ink cartridge according to claim 19, wherein said locking part extends angled away at between 55° and 65° or other predetermined angle relative to the plane of insertion.

21. An ink cartridge according to claim 19, wherein the side edge of said locking part pointing in the direction of the underside of said housing has an arcuate shape and continues into said locking edge.

22. An ink cartridge according to claim 16, wherein a part(s) selected from the group consisting of said locking part, said positioning rail, and said locking part and said positioning rail is/are of the same material as said hinged part and have a material strength selected from the group consisting of from two to five times greater, and three to four and a half times greater, than that of said hinged part.

23. An ink cartridge according to claim 15, wherein said support comprises at least one further positioning element on the underside of said ink cartridge and which, in the inserted state, is supported on the base of said cartridge receptacle.

24. An ink cartridge according to claim 15, wherein said support comprises a positioning peg on the underside of said housing which, in the inserted state, cooperates with a part selected from the group consisting of a positioning aperture of matching shape in the base of said cartridge receptacle, a positioning aperture of matching shape at the base of said cartridge receptacle, and a positioning step protruding from said base.

25. An ink cartridge according to claim 24, wherein a face of said positioning peg, which face rests on said positioning aperture, is of planar form.

26. An ink cartridge according to claim 24, wherein the free end of said positioning peg has a bevel.

27. An ink cartridge according to claim 15, wherein said support comprises at least one positioning aperture provided at the underside of said ink cartridge and which, in the inserted state, is supported on the base of said cartridge receptacle.

28. An ink cartridge according to claim 27, wherein said support comprises a notch(es) selected from the group consisting of at least one notch, and two notches, which is/are formed in side edges of the underside of said ink cartridge and cooperate(s) with an area(s) selected from the group consisting of at least one matching area of ribbing, and two matching areas of ribbing on the base of said cartridge receptacle.
